(19) United States
(12) Patent Application Publication
(10) Pub. No.: US 2016/0348641 A1
(43) Pub. Date: Dec. 1, 2016

(54) HYDROELECTRIC POWER GENERATOR SYSTEM AND METHOD

(71) Applicant: Frederick J. Jessamy, Miramar, FL (US)

(72) Inventor: Frederick J. Jessamy, Miramar, FL (US)

(21) Appl. No.: 14/779,528

(22) PCT Filed: Jul. 19, 2015
(86) PCT No.: PCT/US15/41045

§ 371 Date: Sep. 23, 2015

Related U.S. Application Data
(60) Provisional application No. 62/058,430, filed on Oct. 1, 2014.

(51) Int. Cl. F03B 17/06

(52) U.S. Cl. CPC F03B 17/063

(57) ABSTRACT

A hydroelectric power generating system comprises a horizontal pipe construction, which produces an inflow of water caused by a vacuum initially created within the system. The inflow is used to drive a water turbine located within the respective electrical generating system to produce electrical power.

### FIELD OF THE INVENTION

The present disclosure generally relates to an electrical power generating system. More particularly, the present disclosure relates to a hydroelectric power generating system having a horizontal pipe construction, wherein to produce an inflow of water a vacuum is created in the system. The inflow is used to drive a water turbine located within the respective electrical generating system to produce electrical power.

### BACKGROUND OF THE INVENTION

Hydroelectric power generating systems have been known for decades. Conventional systems utilize a natural geographical location, such as a valley, or the like, and place man-made structures such as a man-made dam across a flowing channel in a natural setting to create a reservoir upstream of the dam. The water is then forced to flow through one or more gates that are interconnected to power generating turbines in the powerhouse located within the dam to create electrical power.

Currently, in order to harness hydropower electricity a massive inflow of water created by a drop or impact is used to drive water turbines. These turbines gain momentum as a continuous inflow of water hits them. However, in order for this approach to function properly locations must be carefully chosen. In some instances, construction is difficult to perform due to terrain. Additionally, variations in water inflow rates created by seasonal changes and droughts can deter electrical production, resulting in financial losses and electrical scarcity. This results in limitations and restrictions as to where hydropower electric stations can be constructed.

Current hydropower electrical systems are located in regions where water flow is driven by gravity. Without gravity to produce water flow, these systems wouldn't have the capability to produce electrical energy. Accordingly, terrain gradients are another limiting factor where a hydropower electrical system can be introduced.

Accordingly, in order to overcome the above mentioned drawbacks, disadvantages and limitations of existing hydroelectric power generating systems, and the growing need for electrical energy in an increasingly growing society, there has never been an ever-increasing demand for a new, efficient, ocean driven hydropower electrical system. It would be highly desirable to provide such a system that integrates all of the necessary functions heretofore performed, without having any of the prior aforementioned drawbacks.

### SUMMARY OF THE INVENTION

The present day disclosure is generally directed to an ocean hydroelectric power generating system, which takes advantage of pressure differentials between the surface and floor of a body of water such as the ocean. The system is comprised of a horizontal pipe structure connected to a water-driven turbine used to harness electrical power. A vacuum is created in the internal cavity of the pipe structure to create/generate suction of the surrounding water mass to provide a constant water flow. An inflow of water is then used to create momentum within the system to drive a turbine connected to an electric generator. Water is then expelled from the system as a continuous flow of water drives the turbines.

The pipe might not require a vacuum or a seal at both ends if inserted deep enough into the body of water. A seal on the end of the pipe inserted into the water might suffice by itself in that situation.

The system uses water to generate essentially “green” energy. The hydroelectric power generating system would make use of salt water from the sea, rather than fresh water, typically used in rivers and streams.

These and other features, aspects, and advantages of the invention will be further understood and appreciated by those skilled in the art by reference to the following written specification, claims, and appended drawings.

### BRIEF DESCRIPTION OF THE DRAWINGS

The invention will hereinafter be described in conjunction with the appended drawings provided to illustrate and not to limit the invention, in which:

FIG. 1 presents a side view of an exemplary hydroelectric power generating system;

FIG. 1B presents a cross-sectional view of the hydroelectric power generating system of FIG. 1A;

FIG. 2A presents a side view of the exemplary hydroelectric power generating system of FIG. 1A, wherein the system is illustrated showing water inflow to drive water turbines;

FIG. 2B presents a cross-sectional view of the sluice showing propellers and generators; and

FIG. 3 presents a flow chart, in accordance with the partial cross sectional views introduced in FIGS. 1-2.

Like reference numerals refer to like parts throughout the several views of the drawings.

### DETAILED DESCRIPTION OF THE INVENTION

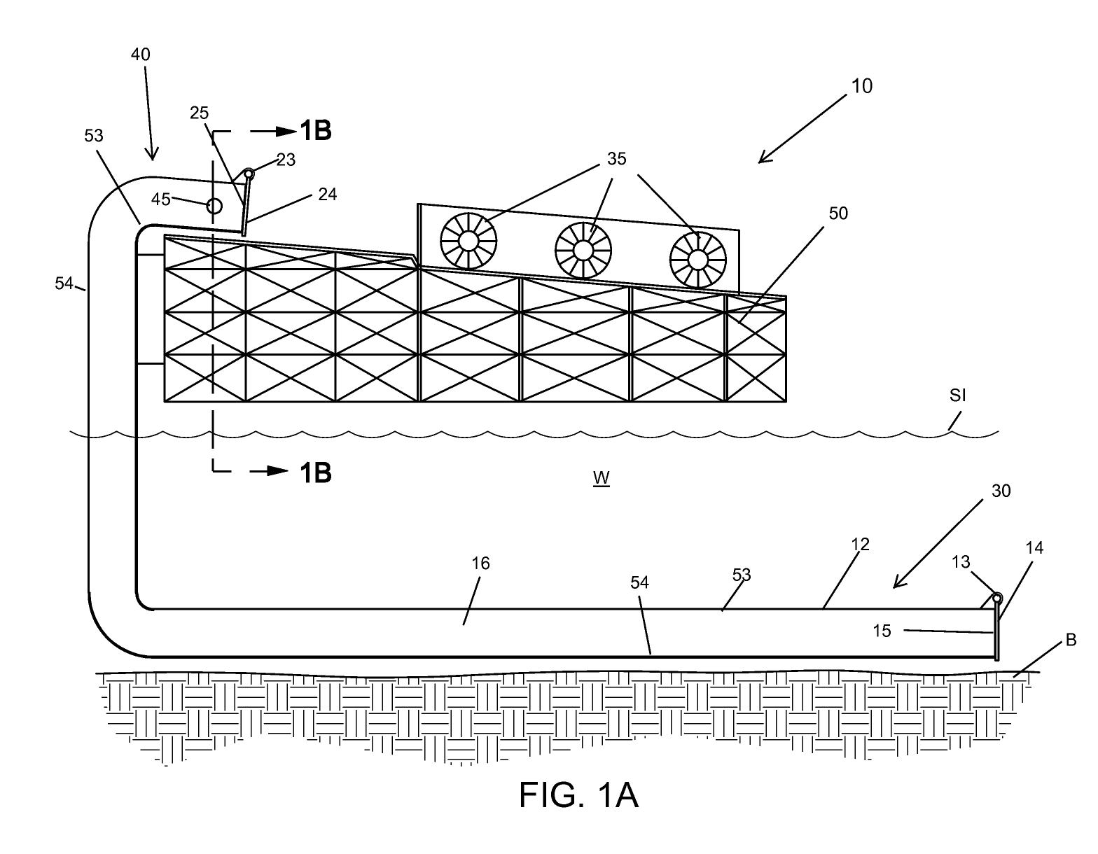

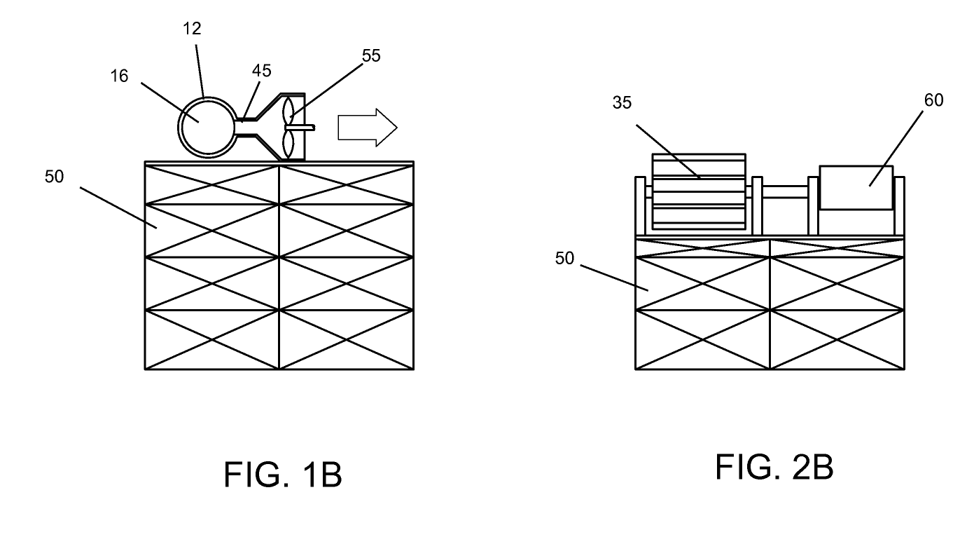

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1A. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

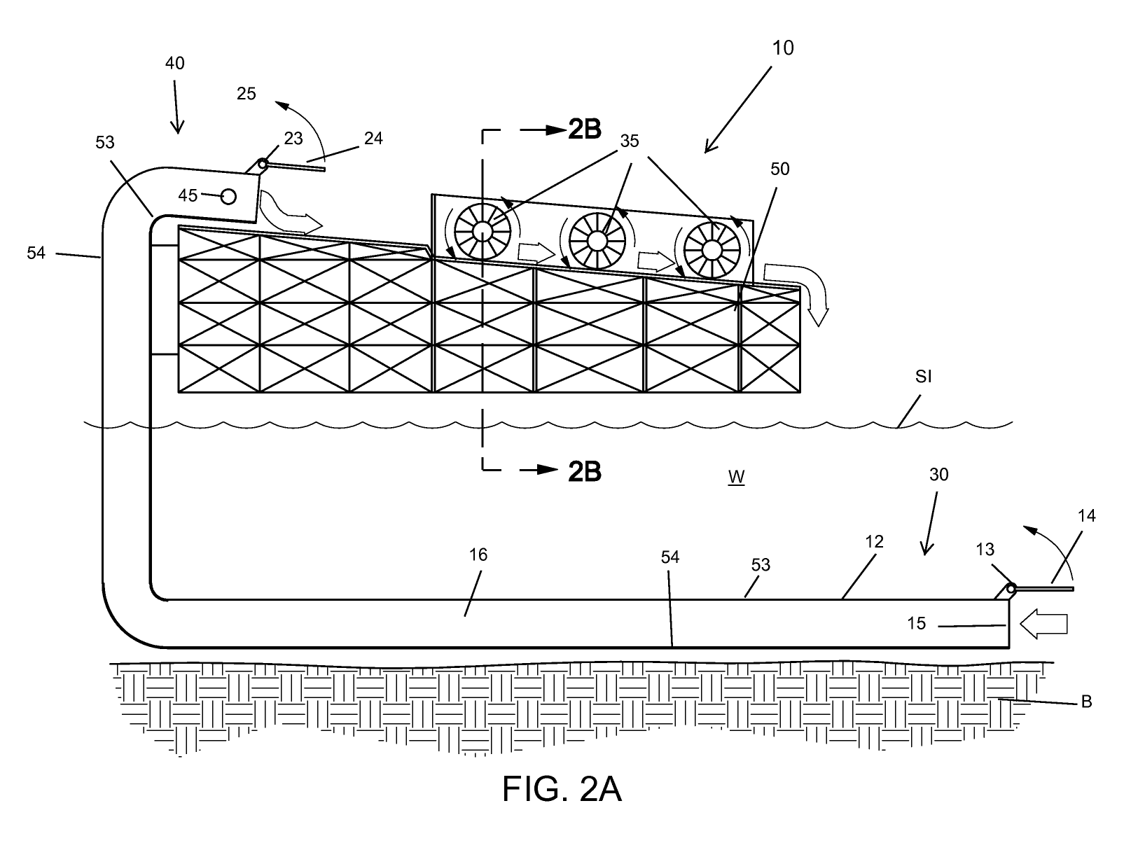

In accordance with the aforementioned invention, an exemplary implementation of a hydroelectric power generator 10 is shown in FIGS. 1-2. As shown in FIG. 1A, hydroelectric power generator 10 comprises elongated pipe 12 running parallel to that of the water surface SI, in a horizontal orientation disposed substantially on the bed B of a body of water W. First end 30 of elongated pipe 12 is submerged in body of water W, and second end 40 of elongated pipe 12 is located above the water surface SI. Elongated pipe 12 comprises first opening 15 that permits inflow of water from body of water W into interior cavity 16 of elongated pipe 12. In the closed position shown in FIG. 1A, elongated pipe 12 is capped off by first exterior cap 14 which is hingedly connected by first hinge 13 to elongated pipe's 12 upper sidewall 53 thus preventing inflow of water. In this closed position, first exterior cap 14 extends to completely cover first opening 15 and removably mates with lower sidewall 54. Elongated pipe 12 further comprises second opening 25 at the other end that permits outflow of water from interior cavity 16 onto sluice 50 and further to propellers 35. Elongated pipe 12 is capped off by second exterior cap 24 which is hingedly connected by second hinge 23 to elongated pipe's 12 lower sidewall 54 thus preventing outflow of water. In this closed position, second exterior cap 24 extends to completely cover second opening 25 and removably mates with upper sidewall 53. Hole 45 is bored on either side of elongated pipe 12 substantially toward second opening 25.

FIG. 1B presents a cross-sectional view of hydroelectric power generating system 10 of FIG. 1A showing sluice 50; elongated pipe 12 and interior cavity 16 of elongated pipe 12; and fan 55 disposed adjacent hole 45 to blow a crosswind across the cross-section of elongated pipe 12 and remove air from interior cavity 16 of elongated pipe 12, creating a vacuum in interior cavity 16.

FIG. 2A presents a side view of hydroelectric power generating system 10 of FIG. 1A, wherein the system is illustrated showing water inflow to drive water turbines. Hydroelectric power generator 10 comprises elongated pipe 12 running parallel to that of the water surface SI, in a horizontal orientation disposed substantially on the bed B of a body of water W. First end 30 of elongated pipe 12 is submerged in body of water W, and second end 40 of elongated pipe 12 is located above the water surface SI. Once a vacuum has been created in interior cavity 16 of elongated pipe 12 by operation of fan 55, first exterior cap 14 and second exterior cap 24 are opened at substantially the same time. Water inflows into interior cavity 16 of elongated pipe 12 through first opening 15, driven by the hydrostatic pressure of the water in body of water X. Water flows out of interior cavity 16 of elongated pipe 12 through second opening 25, onto sluice 50 and through propellers 35.

FIG. 2B presents a cross-sectional view of propellers 35 and generators 60 disposed on sluice 50. As water flows out of elongated pipe 12, it drives propellers 35 which turn generators 60 which produce electricity.

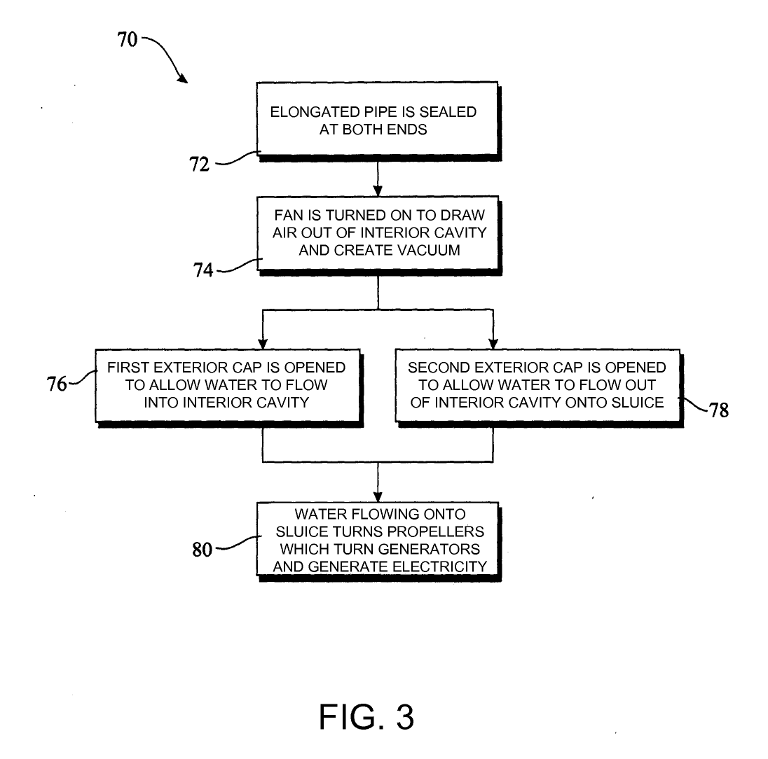

Referring now to FIG. 3, there is shown a flow chart 70 in accordance with the FIGS. 1-2. The flow chart 70 depicts in a structured ordered the steps/events taking place according to the above description. Initially, for the hydroelectric power generating system to initiate the interior cavity must be sealed (see block 72). After the system is sealed, a fan is turned on to create suction within the system (block 74). Once the vacuum is established, simultaneously, the (block 76) first exterior cap is opened and (block 78) the second exterior cap is opened. The pressure differential allows the system to draw an inflow of water into the interior cavity. Water flowing out of the elongated pipe flows along the sluice and turns propellers which turn generators to generate electricity (block 80).

Since many modifications, variations, and changes in detail can be made to the described embodiments and implementations of the invention, it is intended that all matter in the foregoing description and shown in the accompanying drawings be interpreted as illustrative and not in a limiting sense. Thus, the scope of the invention should be determined by the appended claim and their legal equivalence.

What is claimed is:

1. A hydroelectric power generating system, comprising:
an elongated pipe comprising a first end and a second end;
a first cap hingedly covering the first end and a second cap hingedly covering the second end;
a sluice disposed below and substantially adjacent to the second end of the elongated pipe;
a plurality of propellers disposed on the top surface of the sluice;
a plurality of generators disposed on the top surface of the sluice and attached to the propellers;
two substantially opposing holes toward the second end of the elongated pipe; and
a fan disposed substantially adjacent one of the two holes,
wherein the elongated pipe comprises an interior cavity,
wherein the first end of the elongated pipe is located below the surface of a body of water,
wherein the second end of the elongated pipe is located above the surface of the body of water,
wherein the sluice is disposed at an angle decreasing in height from the second end of the elongated pipe.

2. The system of claim 1, wherein the body of water comprises an ocean.

3. The system of claim 1, wherein the body of water comprises a lake.

4. The system of claim 1, wherein the body of water comprises a sea.

5. The system of claim 1, wherein the body of water comprises a river.

6. A method of generating electricity, comprising:
sealing the interior of a hydroelectric power generating system;
creating a vacuum in the interior of the hydroelectric power generating system;
simultaneously allowing water to flow into the hydroelectric power generating system at a first end and out of the system at a second end;
directing the water flowing out of the hydroelectric power generating system to a sluice, the sluice having an angled top surface;
flowing the water through a plurality of propellers disposed on the top surface of the sluice;
driving a plurality of generators by the movement of the propellers; and
generating electricity,
wherein the hydroelectric power generating system comprises the system of claim 1.

7. The method of claim 6, wherein the body of water comprises an ocean.

8. The method of claim 6, wherein the body of water comprises a lake.

9. The method of claim 6, wherein the body of water comprises a sea.

10. The method of claim 6, wherein the body of water comprises a river.

11. The method of claim 6, wherein the vacuum in the interior of the hydroelectric power generating system is created by blowing the fan substantially across the two holes.

12. The method of claim 6, wherein the first cap and the second cap are closed to seal the interior of the hydroelectric power generating system.

13. The method of claim 6, wherein the first cap and the second cap are opened substantially at the same time to allow water to flow into the hydroelectric power generating system at a first end and out of the system at a second end.
